(19) United States
(12) Patent Application Publication
(10) Pub. No.: US 2025/0189868 A1
(43) Pub. Date: Jun. 12, 2025

(54) APERTURE MODULE AND CAMERA MODULE INCLUDING SAME

(71) Applicant: SAMSUNG ELECTRO-MECHANICS CO., LTD., Suwon-si (KR)

(72) Inventor: Jae Hyung HAN, Suwon-si (KR)

(73) Assignee: SAMSUNG ELECTRO-MECHANICS CO., LTD., Suwon-si (KR)

(21) Appl. No.: 18/941,061

(22) Filed: Nov. 8, 2024

(30) Foreign Application Priority Data
Dec. 7, 2023 (KR) 10-2023-0176736

(51) Int. Cl. G03B 9/06; G03B 30/00

(52) U.S. Cl. CPC G03B 9/06; G03B 30/00

(57) ABSTRACT

An aperture module is provided. The aperture module includes a base; a rotator configured to rotate with respect to the base; a plurality of blades configured to form incident holes having different sizes based on a rotation of the rotator; a plurality of ball members disposed between the base and the rotator; a magnet portion disposed on one of the rotator and the base; and a coil portion disposed on another of the rotator and the base, wherein an attractive force acts between the base and the rotator in a diagonal direction between a first axis direction parallel to an optical axis and a second axis direction perpendicular to the first axis direction.

### CROSS-REFERENCE TO RELATED APPLICATIONS

This application claims the benefit under 35 USC § 119(a) of Korean Patent Application No. 10-2023-0176736 filed on Dec. 7, 2023, in the Korean Intellectual Property Office, the entire disclosure of which is incorporated herein by reference for all purposes.

### BACKGROUND

### 1. Field

The following description relates to an aperture module and a camera module including the same.

### 2. Description of Related Art

Camera module are implemented for use in portable electronic devices such as, but not limited to, smartphones, tablet personal computers (PC), and laptops.

Recently, an aperture module that controls the amount of light incident therein has been applied to mobile camera modules.

A typical aperture module may have a plurality of blades that form an incident hole, and may adjust a size of an incident hole by adjusting positions of the plurality of blades with a driver.

However, in a typical aperture module, a space used for arranging the blades may be limited due to the dispositional structure of a driver that drives the aperture module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an aperture module includes a base; a rotator configured to rotate with respect to the base; a plurality of blades configured to form incident holes having different sizes based on a rotation of the rotator; a plurality of ball members disposed between the base and the rotator; a magnet portion disposed on one of the rotator and the base; and a coil portion disposed on another of the rotator and the base, wherein an attractive force acts between the base and the rotator in a diagonal direction between a first axis direction parallel to an optical axis and a second axis direction perpendicular to the first axis direction.

A first yoke may be disposed on the base; and a second yoke may be disposed opposite to the first yoke with respect to the optical axis, wherein the magnet portion comprises a first aperture magnet and a second aperture magnet disposed on opposite sides of each other with respect to the optical axis, and wherein attractive forces act between the first aperture magnet and the first yoke in the first axis direction and the second axis direction.

An attractive force may act between the second aperture magnet and the second yoke in the first axis direction.

A first yoke may be disposed on the base; and a second yoke may be disposed opposite to the first yoke with respect to the optical axis, wherein the magnet portion may include a first aperture magnet and a second aperture magnet disposed on opposite sides of each other with respect to the optical axis, and wherein an attractive force acting between the first aperture magnet and the first yoke may be greater than an attractive force acting between the second aperture magnet and the second yoke.

The base may include a yoke on which a magnetic attractive force that acts with the magnet portion acts, wherein the yoke may include a first yoke and a second yoke disposed on opposite sides of each other with respect to the optical axis, and a cross-section of the first yoke may have an “L” shape.

An area of the first yoke may be wider than an area of the second yoke.

The magnet portion and the coil portion may be disposed to overlap each other in the second axis direction.

The aperture module may further include a first yoke disposed on the base, wherein the magnet portion may include a first aperture magnet and a second aperture magnet disposed on opposite sides of each other with respect to the optical axis, wherein the coil portion may include a first aperture coil and a second aperture coil disposed on opposite sides of each other with respect to the optical axis, and wherein the first yoke, the first aperture magnet, and the first aperture coil may overlap each other in the second axis direction.

A first portion of the plurality of ball members may support the rotator in the first axis direction and the second axis direction, and wherein a second portion of the plurality of ball members may support the rotator in the first axis direction.

The magnet portion may include a first aperture magnet and a second aperture magnet disposed on opposite sides of each other with respect to the optical axis, wherein the plurality of ball members may include a first rolling ball and a second rolling ball, wherein the first rolling ball and the second rolling ball are spaced apart from each other in a circumferential direction of the rotator with the first aperture magnet therebetween, and wherein the first rolling ball and the second rolling ball may support the rotator in the first axis direction and the second axis direction.

In a general aspect, as aperture module includes a base; a rotator disposed to rotate with respect to the base; a plurality of blades configured to form incident holes having different sizes based on a rotation of the rotator; a plurality of ball members disposed between the base and the rotator; a magnet portion disposed on the rotator; a coil portion disposed on the base; and a first yoke disposed on the base, wherein the magnet portion comprises a first aperture magnet and a second aperture magnet disposed on opposite sides of an optical axis, and wherein the first yoke overlaps the first aperture magnet in an optical axis direction and in a direction perpendicular to the optical axis.

The aperture module may further include a second yoke disposed on an opposite side of the first yoke with respect to the optical axis, wherein an attractive force may act between the second aperture magnet and the second yoke in the optical axis direction.

The coil portion may include a first aperture coil that faces the first aperture magnet, and wherein the first aperture coil and the first aperture magnet may be disposed to face each other in a direction perpendicular to the optical axis.

The first yoke may include a horizontal portion perpendicular to the optical axis direction, and a size of the second yoke may be less than a size of the horizontal portion of the first yoke.

A first portion of the plurality of ball members may support the rotator in the optical axis direction and in a direction perpendicular to the optical axis, and a second portion of the plurality of ball members may support the rotator in the optical axis direction.

A portion of the plurality of ball members may include a first rolling ball and a second rolling ball spaced apart from each other in a circumferential direction of the rotator with the first aperture magnet therebetween, and the first rolling ball and the second rolling ball may support the rotator in a direction perpendicular to the optical axis.

In a general aspect, a camera module includes a lens module; and an aperture module, wherein the aperture module includes a base; a rotator configured to rotate with respect to the base; a plurality of blades configured to form incident holes having different sizes based on a rotation of the rotator; a plurality of ball members disposed between the base and the rotator; a magnet portion disposed on one of the rotator and the base; and a coil portion disposed on another of the rotator and the base, wherein an attractive force acts between the base and the rotator in a diagonal direction between a first axis direction parallel to an optical axis and a second axis direction perpendicular to the first axis direction.

Other features and aspects will be apparent from the following detailed description, the drawings, and the claims.

### BRIEF DESCRIPTION OF DRAWINGS

FIG. 1 is a perspective diagram illustrating an example camera module to which an aperture module is coupled, in accordance with one or more embodiments.

FIG. 2 is an exploded perspective diagram illustrating an example camera module from which an aperture module is separated, in accordance with one or more embodiments.

FIG. 3 is a perspective diagram illustrating a state in which an aperture module has a relatively narrow incident hole, in accordance with one or more embodiments.

FIG. 4 is a perspective diagram illustrating a state in which an aperture module has a relatively wide incident hole, in accordance with one or more embodiments.

FIG. 5 is an exploded perspective diagram illustrating an aperture module, in accordance with one or more embodiments.

FIG. 6 is a diagram illustrating a diagram illustrating a dispositional structure of a driver and a yoke of an aperture module, in accordance with one or more embodiments.

FIG. 7 is a diagram illustrating a working relationship of the arrangement and force of attraction between a magnet portion and a yoke of an aperture module, in accordance with one or more embodiments.

FIG. 8 is a plan diagram illustrating a portion of an aperture module, in accordance with one or more embodiments.

FIG. 9 is an exploded perspective diagram illustrating a portion of an aperture module, in accordance with one or more embodiments.

FIG. 10 is a cross-sectional diagram taken along I-I′ in FIG. 8.

FIG. 11 is a cross-sectional diagram taken along II-II′ in FIG. 8.

FIG. 12 is a cross-sectional diagram taken along II-II′ in FIG. 8 without illustrating a rolling ball.

FIG. 13 is an exploded perspective diagram illustrating a camera actuator, in accordance with one or more embodiments.

FIG. 14 is a plan diagram illustrating a connection board of a camera actuator, in accordance with one or more embodiments.

### DETAILED DESCRIPTION

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The one or more examples relate to an aperture module and a camera module including the same, and the camera module may be mounted on portable electronic devices such as, but not limited to, mobile communication terminals, smartphones, and tablet PCs.

One or more examples may provide an aperture module which may ensure a wider dispositional space for blades.

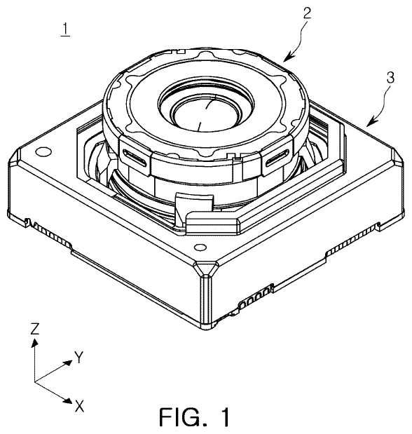

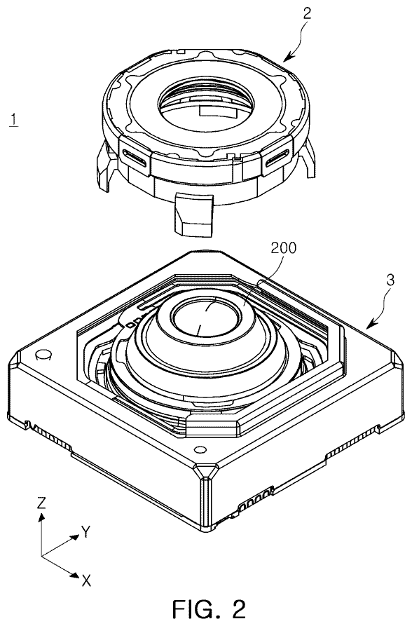

FIG. 1 is a perspective diagram illustrating an example camera module to which an aperture module is coupled according to an embodiment. FIG. 2 is an exploded perspective diagram illustrating a camera module from which an aperture module is separated according to an embodiment.

Referring to FIGS. 1 and 2, a camera module 1, in accordance with one or more embodiments, may include an aperture module 2 and a camera actuator 3.

The camera actuator 3 may include a lens module 200. The lens module 200 may move in an optical axis (Z-axis) direction to perform focus adjustment. Additionally, the lens module 200 may move in a direction perpendicular to the optical axis (Z-axis) to perform optical image stabilization.

The aperture module 2 may be coupled to the camera actuator 3 and may control the amount of light incident to the camera actuator 3. In an example, the aperture module 2 may have an incident hole 21 through which light passes, and the amount of light incident to the camera actuator 3 may be adjusted by changing a size of the incident hole 21.

The aperture module 2 may be coupled to the lens module 200 and may be configured to move together with the lens module 200.

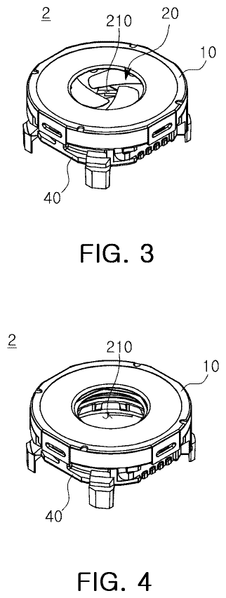

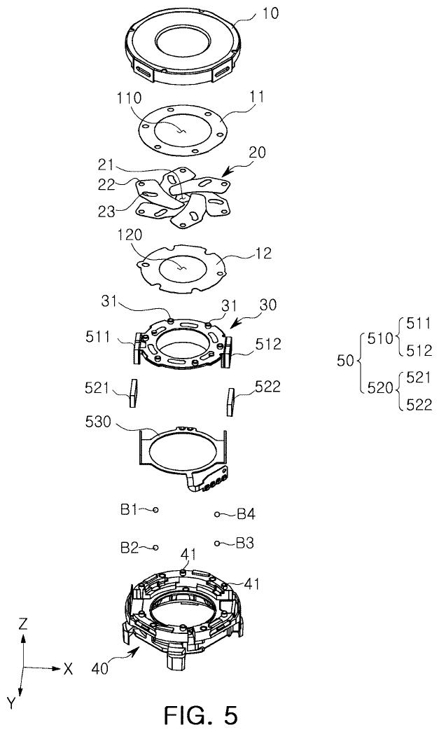

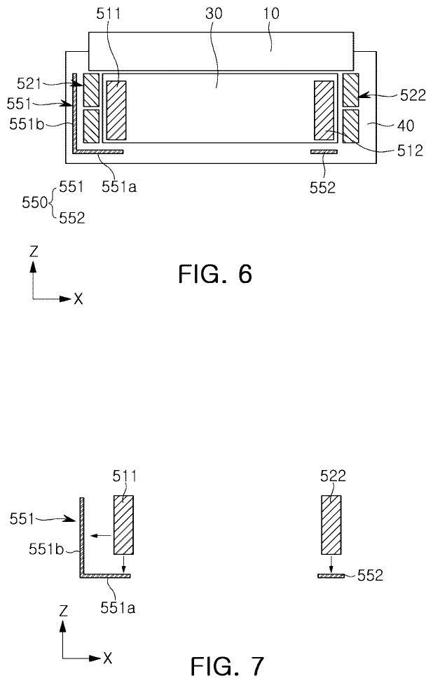

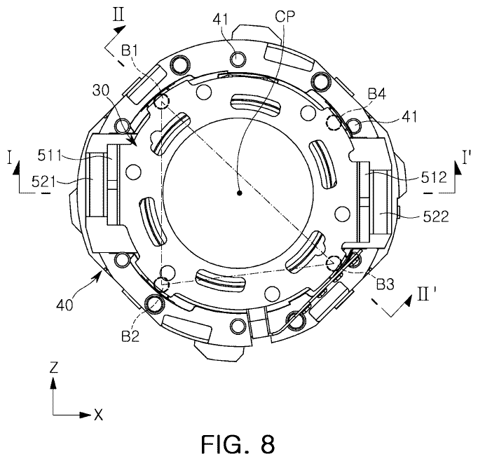

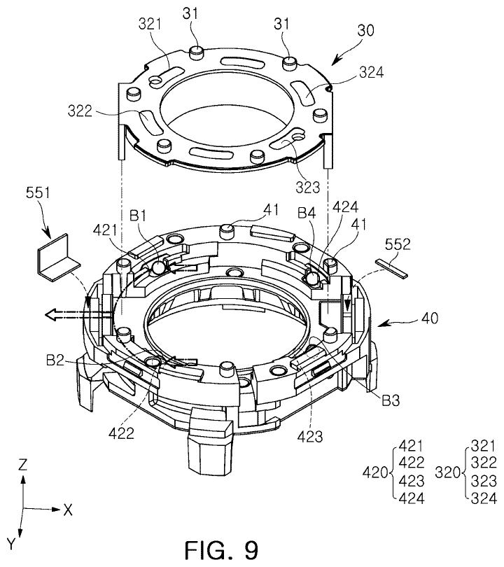

FIG. 3 is a perspective diagram illustrating an example in which an aperture module has a relatively narrow incident hole, in accordance with one or more embodiments. FIG. 4 is a perspective diagram illustrating an example in which an aperture module has a relatively wide incident hole, in accordance with one or more embodiments. FIG. 5 is an exploded perspective diagram illustrating an aperture module, in accordance with one or more embodiments. FIG. 6 illustrates a dispositional structure of a driver and a yoke of an aperture module, in accordance with one or more embodiments. FIG. 7 illustrates a working relationship of the arrangement and force of attraction between a magnet portion and a yoke of an aperture module, in accordance with one or more embodiments. FIG. 8 is a plan diagram illustrating a portion of an aperture module, in accordance with one or more embodiments.

Referring to FIGS. 3 to 5, the aperture module 2, in accordance with one or more embodiments, may include a base 40, a rotator 30, a plurality of blades 20 and an aperture driver 50.

The base 40 may be coupled to the camera actuator 3. In an example, the base 40 may be coupled to a lens module 200 of the camera actuator 3. In this example, the aperture module 2 may move together with the lens module 200 as the lens module 200 moves.

The rotator 30 may rotate relative to the base 40. In an example, the rotator 30 may be spaced apart from the base 40 in the optical axis (Z-axis) direction and may rotate relative to the base 40. As the rotator 30 rotates, the size of the incident hole 21 of the aperture module 2 may change.

A plurality of blades 20 may form the incident hole 21. Each blade may be disposed such that a portion thereof may overlap the other blades in the optical axis (Z-axis) direction. In an example, a set of a plurality of blades (e.g., three blades) and another set of a plurality of blades (e.g., three blades) may be disposed in order in the optical axis (Z-axis) direction. In an example, a portion of one blade may be disposed to overlap the other two blades in the optical axis (Z-axis) direction.

In the embodiment, a total of six blades may be provided, three blades may form one set, and the two sets of blades may be stacked in two layers. However, the number of the plurality of blades 20 is not limited thereto.

The incident hole 21 may be defined by surfaces of each blade directed in the optical axis (Z-axis) direction. A position of each blade may change based on an operation of the aperture driver 50. Accordingly, the size of the incident hole 21 may change depending on the position of each blade.

In an example, as illustrated in FIGS. 3 and 4, the size of the incident hole 21 may decrease or increase based on a rotation of each blade.

The plurality of blades 20 may be coupled to the base 40 and the rotator 30.

Each blade may include a through-hole 22. For example, each blade may have a through-hole 22 on an external side end, and the through-hole 22 may penetrate the blade in the optical axis (Z-axis) direction.

The through-hole 22 of each blade may be coupled to the base 40. For example, a plurality of protrusions 41 protruding in the optical axis (Z-axis) direction may be disposed on the base 40, and each protrusion 41 may be coupled to the through-hole 22 of each respective blade. Each protrusion 41 may form a rotational shaft of each blade. The protrusions 41 and the through-holes 22 may have corresponding sizes, respectively.

Additionally, each blade may include a guide hole 23. For example, each blade may have a guide hole 23 disposed in a position spaced apart from the through-hole 22.

The guide hole 23 of each blade may be coupled to the rotator 30. For example, a plurality of guide protrusions 31 protruding in the optical axis (Z-axis) direction may be disposed on the rotator 30, and each guide protrusion 31 may be coupled to the guide hole 23 of each blade. The guide hole 23 may have a size larger than a size of the guide protrusion 31. For example, a width of the guide hole 23 may correspond to a diameter of the guide protrusion 31, and a length of the guide hole 23 may be larger than the diameter of the guide protrusion 31.

A shape of the guide hole 23 is not limited thereto. For example, when the guide hole 23 is able to move the position of the blade in conjunction with movement of the rotator 30, the shape of the guide hole 23 may change.

Accordingly, as the rotator 30 rotates, each guide protrusion 31 may move within each guide hole 23, and accordingly, each blade may rotate using the protrusion 41 of the base 40 as a rotational shaft.

The aperture module 2, in accordance with one or more embodiments, may further include a cover 10. The cover 10 may be coupled to the base 40. The plurality of blades 20 and the rotator 30 may be disposed in a space between the cover 10 and the base 40.

A first spacer 11 may be disposed between the plurality of blades 20 and the cover 10. For example, the first spacer 11 may be coupled to the rotator 30 and may be disposed between the plurality of blades 20 and the cover 10. The first spacer 11 may cover at least a portion of an upper surface of the plurality of blades 20. In an example, a surface of the first spacer 11 may be coated black.

The first spacer 11 may have a through-hole 110 through which light passes, and a size of the through-hole 110 of the first spacer 11 may be larger than a maximum size of the incident hole 21 formed by the plurality of blades 20.

A second spacer 12 may be disposed between the rotator 30 and the plurality of blades 20. For example, the second spacer 12 may be coupled to the rotator 30 and may be disposed between the rotator 30 and the plurality of blades 20. The second spacer 12 may cover at least a portion of a lower surface of the plurality of blades 20. In an example, a surface of the second spacer 12 may be coated black.

The second spacer 12 may have a through-hole 120 through which light passes, and the size of the through-hole 120 of the second spacer 12 may be larger than a maximum size of the incident hole 21 formed by the plurality of blades 20. In an example, the size of through-hole 120 of the second spacer 12 may be smaller than the size of the through-hole 110 of the first spacer 11.

The aperture driver 50 may move the rotator 30 to change the size of the incident hole 21. For example, the aperture driver 50 may generate a driving force to rotate the rotator 30.

As the rotator 30 rotates, the guide protrusion 31 of the rotator 30 may move within the guide hole 23 of the plurality of blades 20, and accordingly, the plurality of blades 20 may rotate using the protrusion 41 of the base 40 as a rotational shaft, such that the size of the incident hole 21 may change.

The aperture driver 50 may include a magnet portion 510 and a coil portion 520. The magnet portion 510 and the coil portion 520 may be disposed to face each other in a direction perpendicular to the optical axis (Z-axis).

The magnet portion 510 may be disposed on one of the rotator 30 and the base 40, and the coil portion 520 may be disposed on the other.

In an example, the magnet portion 510 may be mounted on the rotator 30. As an example, the magnet portion 510 may be mounted on a side surface of the rotator 30.

The magnet portion 510 may include a plurality of aperture magnets spaced apart from each other. As an example, the magnet portion 510 may include a first aperture magnet 511 and a second aperture magnet 512 disposed on opposite sides of the optical axis (Z-axis).

The first and second aperture magnets 511 and 512 may be magnetized such that one surface (e.g., the surface facing the coil portion 520 may have both N and S poles. For example, one surface of the first aperture magnet 511 and the second aperture magnet 512 facing the coil portion 520 may have an N pole, a neutral region, and an S pole in order in a direction perpendicular to the optical axis (Z-axis).

The coil portion 520 may be disposed to face the magnet portion 510. For example, the coil portion 520 may be disposed to face the magnet portion 510 in a direction perpendicular to the optical axis (Z-axis).

The coil portion 520 may be disposed on the aperture substrate 530. The aperture substrate 530 may be disposed on the base 40. As an example, the aperture substrate 530 may be mounted on an upper surface of the base 40. The coil portion 520 may receive a current through the aperture substrate 530. The coil portion 520 may include a plurality of aperture coils. As an example, the coil portion 520 may include a first aperture coil 521 and a second aperture coil 522 disposed on opposite sides of the optical axis (Z-axis). The coil portion 520 may include a plurality of aperture coils. As an example, the coil portion 520 may include a first aperture coil 521 and a second aperture coil 522 disposed on opposite sides of the optical axis (Z-axis).

The coil portion 520 may include a plurality of aperture coils. As an example, the coil portion 520 may include the first aperture coil 521 and the second aperture coil 522 disposed on opposite sides of the optical axis (Z-axis).

The magnet portion 510 may be configured as a moving member mounted on the rotator 30 and rotating together with the rotator 30, and the coil portion 520 may be configured as a fixed member fixed to the base 40.

In another embodiment, positions of the magnet portion 510 and the coil portion 520 may be switched with each other. In this example, since the coil portion 520 and the aperture substrate 530 are mounted on the rotator 30 and rotate together with the rotator 30, at least a portion of the aperture substrate 530 may be configured to be flexible.

When power is applied to the coil portion 520, the rotator 30 may rotate based on an electromagnetic force between the magnet portion 510 and the coil portion 520.

The yoke may be described with reference to FIGS. 6 to 7.

FIG. 6 illustrates a dispositional structure of a driver and a yoke of an aperture module, in accordance with one or more embodiments. FIG. 7 illustrates a working relationship of the arrangement and the force of attraction between a magnet portion and a yoke of an aperture module, in accordance with one or more embodiments.

The yoke 550 may be disposed in the base 40. The yoke 550 may be a pulling yoke. The yoke 550 may be formed of a metal or magnetic material. Accordingly, a magnetic attractive force may act between the yoke 550 and the magnet portion 510.

The yoke 550 may be combined with the base 40. The yoke 550 may be coupled to a surface of the base 40. In this example, a groove or a space in which the yoke 550 is disposed may be formed on a surface of the base 40. The yoke 550 may be disposed in the base 40. In other words, the yoke 550 may be inserted into the base 40. In other words, the base 40 may be manufactured by an insert injection method with the yoke 550 disposed therein.

The yoke 550 may include a first yoke 551 and a second yoke 552. The first yoke 551 and the second yoke 552 may be disposed on opposite sides with the optical axis interposed therebetween.

The first yoke 551 may refer to a yoke having a size relatively larger than a size of the second yoke 552. Accordingly, an attractive force acting between the first yoke 551 and the first aperture magnet 511 may be greater than an attractive force acting between the second yoke 552 and the second aperture magnet 512.

The first yoke 551 may include a horizontal portion 551a and a vertical portion 551b. As an example, the first yoke 551 may have an “L” shape in which the horizontal portion 551a and the vertical portion 551b are coupled to each other. As another example, the horizontal portion 551a and the vertical portion 551b may be provided as independent components and may be spaced apart from each other in a direction perpendicular to each other.

The horizontal portion 551a may extend in a direction perpendicular to the optical axis, and the vertical portion 551b may extend in the optical axis direction. A size of the horizontal portion may be configured to be larger than a size of the second yoke 552.

The first yoke 551 may be disposed to overlap the first aperture magnet 511 in two axis directions. Referring to FIG. 7, the first yoke 551 may overlap the first aperture magnet 511 in first axis direction. In an example, the first axis direction may be a direction parallel to the optical axis. The first yoke 551 may overlap the first aperture magnet 511 in the second axis direction. In an example, the second axis direction may be the X-axis direction with respect to FIG. 7 and may be a direction perpendicular to the optical axis. By this structure, magnetic attractive force may be formed between the first aperture magnet 511 and the first yoke 551 in two directions. Accordingly, an attractive force may act between the first aperture magnet 511 and the first yoke 551 in a diagonal direction between the first axis direction and the second axis direction.

The second yoke 552 may refer to a yoke having an area relatively smaller than an area of the first yoke 551. The area of the second yoke 552 may be smaller than the area of the horizontal portion of the first yoke 551. The second yoke 552 may overlap the second aperture magnet 512 in the first axis direction. In an example, the first axis direction may refer to the Z-axis direction and may refer to the direction parallel to the optical axis. Accordingly, an attractive force may act between the second yoke 552 and the second aperture magnet 512 in the first axis direction.

Considering the attractive force acting between the first yoke 551 and the first aperture magnet 511 and the attractive force acting between the second yoke 552 and the second aperture magnet 512, attractive force acting in the first axis direction and attractive force acting in the second axis direction may act together between the base 40 and the rotator 30.

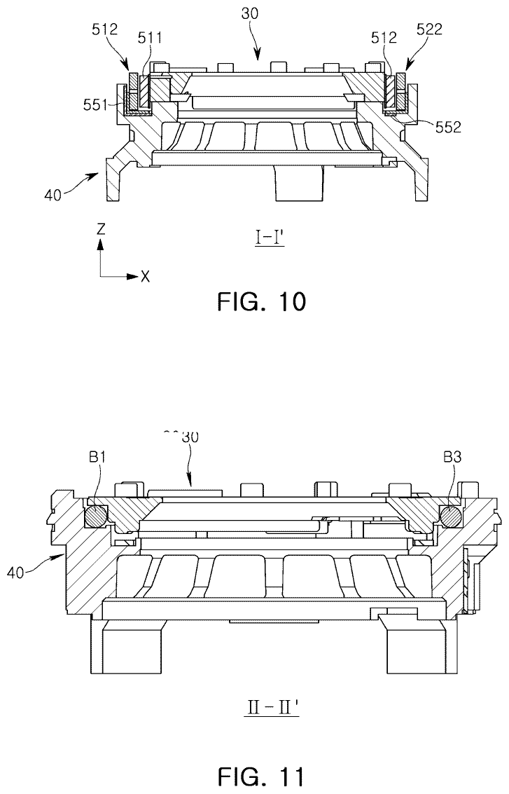

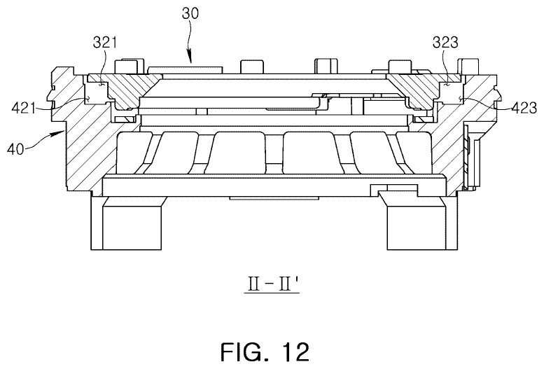

FIG. 8 is a plan diagram illustrating a portion of an aperture module, in accordance with one or more embodiments. FIG. 9 is an exploded perspective diagram illustrating a portion of an aperture module, in accordance with one or more embodiments. FIG. 10 is a cross-sectional diagram taken along I-I′ in FIG. 8. FIG. 11 is a cross-sectional diagram taken along II-II′ in FIG. 8. FIG. 12 is a cross-sectional diagram taken along II-II′ in FIG. 8 without illustrating a rolling ball. A rolling ball disposed between the base 40 and the rotator 30 may be described with reference to FIGS. 9 and 12.

Referring to FIG. 8, the rolling portion may include a plurality of ball members, which include a first rolling ball B1 and a second rolling ball B2, and may further include a third rolling ball B3 and a fourth rolling ball B4. The first to third rolling balls B1, B2, and B3 may be spaced apart from each other in a circumferential direction of the base 40.

The first rolling ball B1 and the second rolling ball B2 may be disposed closer to the first aperture magnet 511 than to the second aperture magnet 512. The third rolling ball B3 may be disposed closer to the second aperture magnet 512 than to the first aperture magnet 511. The relative position of the fourth rolling ball B4 with respect to the magnet portion 510 is not limited to any particular example.

Referring to FIG. 9, a guide groove portion may be disposed on a surface on which the base 40 and the rotator 30 face each other. For example, the first guide groove portion 420 may be disposed on the base 40, and the second guide groove portion 320 may be disposed on the rotator 30.

The first rolling ball B1, second rolling ball B2, third rolling ball B3, and fourth rolling ball B4 may be respectively disposed between the first guide groove portion 420 and the second guide groove portion 320.

The first guide portion groove 420 may include a 1-1 guide groove 421, a 1-2 guide groove 422, a 1-3 guide groove 423 and a 1-4 guide groove 424. The 1-1 guide groove 421 to the 1-4 guide groove 424 may be spaced apart from each other in a circumferential direction of the base 40.

The 1-1 guide groove 421 to the 1-4 guide groove 424 may include a bottom surface formed on one surface (e.g., an upper surface) of the base 40 and a side surface that extends from a bottom surface in the optical axis direction.

The second guide portion groove 320 may include a 2-1 guide groove 321, a 2-2 guide groove 322, a 2-3 guide groove 323 and a 2-4 guide groove 324. The 2-1 guide groove 321 to the 2-4 guide groove 324 may be spaced apart from each other in a circumferential direction of the rotator 30.

The 2-1 guide groove 321 to the 2-4 guide groove 324 may include a bottom surface formed on one surface (e.g., lower surface) of the rotator 30 and a side surface that extends from a bottom surface in the optical axis direction, respectively.

The 1-1 guide groove 421 and the 2-1 guide groove 321 may be disposed to face each other, and the first rolling ball B1 may be disposed in a space between the 1-1 guide groove 421 and the 2-1 guide groove 321.

The 1-2 guide groove 422 and the 2-2 guide groove 322 may be disposed to face each other, and a second rolling ball B2 may be disposed in a space between the 1-2 guide groove 422 and the 2-1 guide groove 322.

The 1-3 guide groove 423 and the 2-3 guide groove 323 may be disposed to face each other, and the third rolling ball B3 may be disposed in a space between the 1-3 guide groove 423 and the 2-3 guide groove 323.

A bottom surface of the 1-1 guide groove 421 and a bottom surface of the 2-1 guide groove 321 may face each other in the optical axis (Z-axis) direction, and a side surface of the 1-1 guide groove 421 and a side surface of the 2-1 guide groove 321 may face each other in a direction perpendicular to the optical axis (Z axis).

A bottom surface of the 1-2 guide groove 422 and a bottom surface of the 2-2 guide groove 322 may face each other in the optical axis (Z-axis) direction, and a side surface of the 1-2 guide groove 422 and a side surface of the 2-2 guide groove 322 may face each other in a direction perpendicular to the optical axis (Z axis).

A bottom surface of the 1-3 guide groove 423 and a bottom surface of the 2-3 guide groove 323 may face each other in the optical axis direction, and a side surface of the 1-3 guide groove 423 and a side surface of the 2-3 guide groove 323 may face each other in a direction perpendicular to the optical axis (Z axis).

The first rolling ball B1 may be in two-point contact with each of the 1-1 guide groove 421 and the 2-1 guide groove 321.

The second rolling ball B2 may be in two-point contact with each of the 1-2 guide groove 422 and the 2-2 guide groove 322.

The first rolling ball B1, the 1-1 guide groove 421, the 1-2 guide groove 422, the second rolling ball B2, the 2-1 guide groove 321, and the 2-2 guide groove 322 may operate as main guides to guide a rotation of the rotator 30.

The 1-3 guide groove 423 and the 2-3 guide groove 323 may be disposed to face each other, and the third rolling ball B3 may be disposed in a space between the 1-3 guide groove 423 and the 2-3 guide groove 323.

A bottom surface of the 1-3 guide groove 423 and a bottom surface of the 2-3 guide groove 323 may face each other in the optical axis (Z-axis) direction, and a side surface of the 1-3 guide groove 423 and a side surface of the 2-3 guide groove 323 may face each other in a direction perpendicular to the optical axis (Z axis).

The third rolling ball B3 may be in contact with the 1-3 guide groove 423 and the 2-3 guide groove 323. The number of contact points between the second rolling member RB2, and the 1-3 guide groove 423 and the 2-3 guide groove 323 may be two or three.

When the number of contact points between the third rolling ball B3, and the 1-3 guide groove 423 and the 2-3 guide groove 323 is two, the third rolling ball B3 may be in contact with a bottom surface of the 1-3 guide groove 423 and a bottom surface of the 2-3 guide groove 323.

When the number of contact points between the third rolling ball B3, and the 1-3 guide groove 423 and the 2-3 guide groove 323 is three, the third rolling ball B3 may be in contact with a bottom surface of the 1-3 guide groove 423 and a bottom surface of the 2-3 guide groove 323, and may be in contact with the side surface of the 1-3 guide groove 423 or the side surface of the 2-3 guide groove 323.

A distance between surfaces of the 1-3 guide grooves 423 and the 2-3 guide groove 323 facing each other in a direction perpendicular to the optical axis (Z axis) direction may be greater than a diameter of the third rolling ball B3.

The third rolling ball B3, the 1-3 guide groove 423 and the 2-3 guide groove 323 may operate as an auxiliary guide to support a rotation of the rotator 30.

When viewed in the optical axis (Z-axis) direction, the rotator 30 may be three-point supported on the base 40 by the first rolling ball B1, the second rolling ball B2 and the third rolling ball B3.

The 1-4 guide groove 424 and the 2-4 guide groove 324 may be disposed to face each other, and the fourth rolling ball B4 may be disposed in a space between the 1-4 guide groove 424 and the 2-4 guide groove 324.

A bottom surface of the 1-4 guide groove 424 and a bottom surface of the 2-4 guide groove 324 may face each other in the optical axis (Z-axis) direction, and a side surface of the 1-4 guide groove 424 and a side surface of the 2-4 guide groove 324 may face each other in a direction perpendicular to the optical axis (Z axis).

The fourth rolling ball B4 may be in contact with at least one of the 1-4 guide groove 424 and the 2-4 guide groove 324. The number of contact points between the fourth rolling ball B4, and the 1-4 guide groove 424 and the 2-4 guide groove 324 may be one or two.

In an example, when the number of contact points between the fourth rolling ball B4, and the 1-4 guide groove 424 and the 2-4 guide groove 324 is one, the fourth rolling ball B4 may be in contact with a bottom surface of the 1-4 guide groove 424 or a bottom surface of the 2-4 guide groove 324.

When the number of contact points between the fourth rolling ball B4, and the 1-4 guide groove 424 and the 2-4 guide groove 324 is two, the fourth rolling ball B4 may be in one-point contact with one of the bottom surface of the 1-4 guide groove 424 and the bottom surface of the 2-4 guide groove 324, and may be in one-point contact with the side surface of the 1-4 guide groove 424 or the side surface of the 2-4 guide groove 324.

A distance in the optical axis (Z-axis) direction between the bottom surface of the 1-4 guide groove 424 and the bottom surface of the 2-4 guide groove 324 may be larger than a distance in the optical axis (Z axis) direction between the bottom surface of 1-1 guide groove 421 and the bottom surface of 2-1 guide groove 321.

In an example, a diameter of the fourth rolling ball B4 may be less than diameters of the first rolling ball B1, the second rolling ball B2 and the third rolling ball B3.

The fourth rolling portion B4 may operate to prevent the rotator 30 from tilting with respect to the base 40 in the event of an external impact. In other words, by preventing the rotator 30 from tilting with respect to the base 40 in the event of an external impact, a rolling portion may be prevented from being separated from the base 40 and the rotator 30.

The fourth rolling ball B4 may be an optional component, and when the fourth rolling ball B4 is not provided, tilting of the rotator 30 may be prevented by adjusting the positions of the first rolling ball B1, the second rolling ball B2 and the third rolling ball B3.

When viewed in the optical axis (Z-axis) direction, the rotator 30 may be three-point supported on the base 40 by the first rolling ball B1, the second rolling ball B2 and the third rolling ball B3.

In this example, for the rotator 30 to stably rotate, a central point CP of attractive force acting between the magnet portion 510 and the yoke 550 may need to be disposed in a support region formed by connecting contact points between the first rolling ball B1 and the base 40 (or the rotator 30, contact points between the second rolling ball B2 and the base 40 (or the rotator 30, and contact points between the third rolling ball B3 and the base 40 (or the rotator 30.

Since the support region becomes wider toward the first rolling ball B1 and the second rolling ball B2, it may be necessary to dispose the central point CP of attractive force closer to the first rolling ball B1 and the second rolling ball B2.

Accordingly, the central point CP of attractive force may be disposed closer to the first rolling ball B1 and the second rolling ball B2 by configuring the first yoke 551 and the second yoke 552 to have different sizes. The area of the first yoke 551 facing the first aperture magnet 511 may be larger than the area of the second yoke 552 facing the second aperture magnet 512.

In other words, by configuring the size of the first yoke 551 to be larger than the size of the second yoke 552, the central point CP of attractive force may be disposed closer to the first rolling member RB1.

As another example, the size of the first aperture magnet 511 may be configured to be larger than the size of the second aperture magnet 512 such that the central point CP of attractive force may be disposed closer to the first rolling ball B1 and the second rolling ball B2.

As another example, by configuring the distance between the first aperture magnet 511 and the first yoke 551 in the optical axis (Z-axis) direction to be narrower than the distance between the second aperture magnet 512 and the second yoke 552 in the optical axis (Z-axis) direction, the central point CP of attractive force may be disposed closer to the first rolling ball B1 and the second rolling ball B2.

Since the first yoke 551 includes a horizontal portion 551a and a vertical portion 551b, attractive force may be applied in the optical axis direction (Z-axis) by the first aperture magnet 511 and the first yoke 551, and attractive force may act in a direction intersecting the optical axis (e.g., a direction perpendicular to the optical axis or a direction intersecting the optical axis and inclined downwardly).

In other words, attractive force may act on the first aperture magnet 511 in at least two directions intersecting each other.

Due to the attractive force in the optical axis direction acting between the first aperture magnet 511 and the first yoke 551, the rotator 30 including the first aperture magnet 511 may be pulled in the optical axis direction toward the base 40 including the first pulling yoke 551.

Accordingly, due to the attractive force acting between the first aperture magnet 511 and the first yoke 551, the first rolling ball B1 may be in contact with the bottom surface of the 1-1 guide groove 421 and the bottom surface of the 2-1 guide groove 321.

Additionally, due to the attractive force acting between the first aperture magnet 511 and the first yoke 551, the second rolling ball B2 may be in contact with the bottom surface of the 1-2 guide groove 422 and the bottom surface of the 2-2 guide groove 322.

Due to the attractive force perpendicular to the optical axis direction acting between the first aperture magnet 511 and the first yoke 551, the rotator 30 including the first aperture magnet 511 may be pulled in a direction intersecting the optical axis towards the base 40 including the first yoke 551.

Accordingly, due to the attractive force perpendicular to the optical axis direction acting between the first aperture magnet 511 and the vertical portion 551b, the first rolling ball B1 may be in contact with the side surface of the 1-1 guide groove 421 and the side surface of the 2-1 guide groove 321.

Due to the attractive force acting between the first aperture magnet 511 and the vertical portion 551b, the second rolling ball B2 may be in contact with the side surface of the 1-2 guide groove 422 and the side surface of the 2-2 guide groove 322.

Accordingly, due to the attractive force acting between the first aperture magnet 511 and the vertical portion 551b, the second rolling ball B2 may be in contact with the side surface of the 1-2 guide groove 422 and the side surface of the 2-2 guide groove 322.

The side surface of the 1-1 guide groove 421, the side surface of the 1-2 guide groove 422, the side surface of the 2-1 guide groove 321, and the side surface of the 2-2 guide groove 322 may be configured to be curved. For example, the radius of curvature of the side surface of the 1-1 guide groove 421, the radius of curvature of the side surface of the 1-2 guide groove 422, the radius of curvature of the side surface of the 2-1 guide groove 321 and the radius of curvature of the side surface of the 2-2 guide groove 322 may be the same.

A conceptual circle passing through the side surface of the 1-1 guide groove 421 and the side surface of the 1-2 guide groove 422, and a conceptual circle passing through the side surface of the 2-1 guide groove 321 and the side surface of the 2-2 guide groove 322 may be concentric.

When a driving force is generated by the aperture driver 500, the first rolling ball B1 may roll along a side surface of the 1-1 guide groove 421 and the side surface of the second rolling ball B1 may roll along the side surface of the 1-2 guide groove 422 and the side surface of the 2-2 guide groove 322.

Accordingly, the rotator 30 may rotate by being guided by the first rolling ball B1 and the second rolling ball B2.

When the rotator 30 rotates, the third rolling ball B3 may maintain the state of being in contact with the bottom surface of the 1-3 guide groove 423 and the bottom surface of the 2-3 guide groove 323, and the rotator 30 may maintain the three-point support form with respect to the rolling portion.

In an embodiment, the aperture module 2 may sense the position of the rotator 30.

Accordingly, an aperture position sensor may be provided. The aperture position sensor may be disposed on the aperture substrate 530 to face the magnet portion 510. For example, the aperture position sensor may face at least one of the first aperture magnet 511 and the second aperture magnet 512 in the optical axis direction. The aperture position sensor 530 may be configured as a Hall sensor.

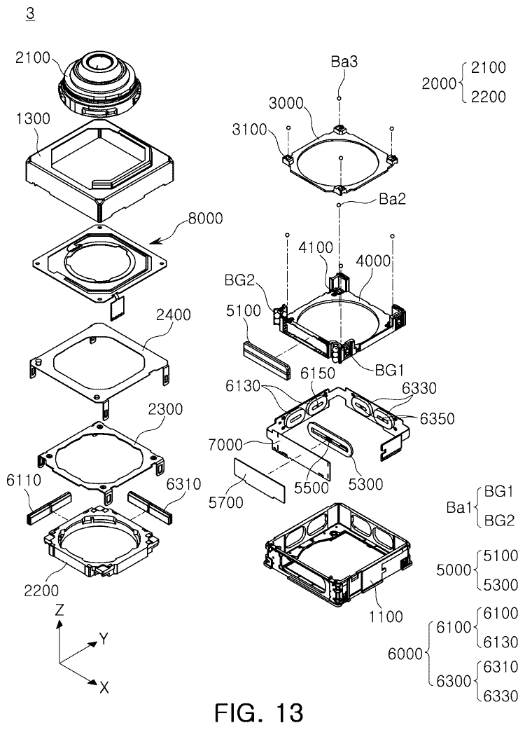

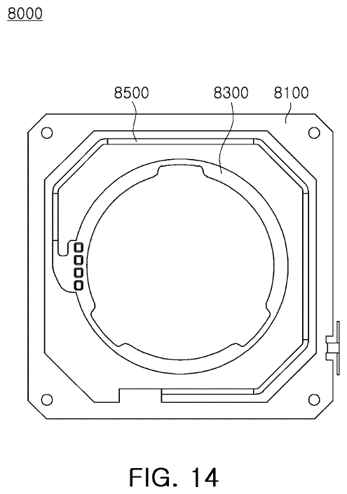

FIG. 13 is an exploded perspective diagram illustrating an example camera actuator, in accordance with one or more embodiments. FIG. 14 is a plan diagram illustrating a connection board of an example camera actuator, in accordance with one or more embodiments.

Referring to FIG. 13, a camera actuator 3, in accordance with one or more embodiments, may include a lens module 2000 and a housing 1100 that accommodates the lens module 2000.

Additionally, the camera actuator 3 may further include a guide frame 3000, a carrier 4000, a case 1300 and an image sensor module.

In the embodiment described below, an example in which the base 40 of the aperture module 2 is coupled to the lens module 2000 of the camera actuator 3 may be described. In this example, the aperture module 2 may move together with the lens module 2000 as the lens module 2000 moves.

The carrier 4000 may be disposed in the housing 1100 and may move relative to the housing 1100 in the optical axis (Z-axis) direction.

The lens module 2000 may be disposed on the carrier 4000, and the carrier 4000 and the lens module 2000 may move together in the optical axis direction. Accordingly, a distance between the lens module 2000 and the image sensor may change to adjust a focus.

The guide frame 3000 may be disposed between the carrier 4000 and the lens module 2000. The guide frame 3000 may function to guide the lens module 2000 to move in a direction perpendicular to the optical axis (Z-axis) direction.

The lens module 2000 may move in a direction perpendicular to the optical axis direction to correct shaking while photographing.

The lens module 2000 may include a lens barrel 2100 and a lens holder 2200. The lens barrel 2100 may have a hollow cylindrical shape, and at least one lens for imaging a subject may be accommodated in the lens barrel 2100. When a plurality of lenses are disposed in the lens barrel 2100, the plurality of lenses may be mounted on the lens barrel 2100 along the optical axis.

The lens barrel 2100 may be coupled to the lens holder 2200. Accordingly, the lens barrel 2100 and the lens holder 2200 may move together.

The base 40 of the aperture module 2 may be coupled to the lens holder 2200.

The lens module 2000 may be accommodated in the housing 1100. For example, the housing 1100 may have an open upper portion and an open bottom shape, the carrier 4000 may be disposed in an internal space of housing 1100, and the lens module 2000 may be accommodated in the carrier 4000.

The camera actuator 3 may adjust a focus by moving the lens module 2000 in the optical axis (Z-axis) direction, and may correct shaking while photographing by moving the lens module 2000 in the direction perpendicular to the optical axis (Z-axis).

The camera actuator 3 may include a focusing driver 5000 that moves the lens module 2000 in the optical axis direction, and a stabilization driver 6000 that moves the lens module 2000 in a direction perpendicular to the optical axis direction.

The image sensor module may be configured as a device that converts incident light into an electrical signal through the lens module 2000.

In an example, the image sensor module may include an image sensor and a printed circuit board connected to the image sensor, and may further include an infrared filter.

The infrared filter may block light in an infrared region of light incident to the lens module 2000.

The image sensor may convert incident light into an electrical signal through the lens module 2000. As an example, the image sensor may be implemented as a charge coupled device (CCD) or a complementary metal-oxide semiconductor (CMOS).

The electrical signal converted by the image sensor may be output as an image through a display device of a portable electronic device.

The image sensor may be fixed to the printed circuit board, and may be electrically connected to the printed circuit board by wire bonding.

The image sensor module may be disposed below the housing 1100.

The case 1300 may be coupled to the housing 1100 to surround an external surface of housing 1100, and may operate to protect the internal components of the camera actuator 3.

The focusing driver 5000 may move the lens module 2000 to focus on a subject. For example, the focusing driver 5000 may move the carrier 4000 by generating a driving force in the optical axis direction. Since the lens module 2000 is disposed in the carrier 4000, the carrier 4000 and the lens module 2000 may move together in the optical axis direction based on a driving force of the focusing driver 5000.

Additionally, since the base 40 of the aperture module 2 is coupled to the lens module 2000, the aperture module 2 may also move in the optical axis direction together with the lens module 2000.

The focusing driver 5000 may include a first magnet 5100 and a first coil 5300. The first magnet 5100 and the first coil 5300 may be disposed to face each other in a direction perpendicular to the optical axis.

The first magnet 5100 may be mounted on the carrier 4000. In an example, the first magnet 5100 may be mounted on one side surface of the carrier 4000.

The first magnet 5100 may be magnetized such that one surface (e.g., the surface facing the first coil 5300 may have both the N pole and the S pole. In an example, one surface of the first magnet 5100 facing the first coil 5300 may include an N pole, a neutral region, and an S pole in order in the optical axis direction.

The first coil 5300 may be disposed to face the first magnet 5100. For example, the first coil 5300 may be disposed to face the first magnet 5100 in a direction perpendicular to the optical axis (Z-axis).

The first coil 5300 may be disposed on the substrate 7000, and the substrate 7000 may be mounted on the housing 1100 such that the first magnet 5100 and the first coil 5300 may face each other in a direction perpendicular to the optical axis. In an example, the first coil 5300 may be disposed on one surface of the substrate 7000. The substrate 7000 may be mounted on a side surface of the housing 1100 such that the first magnet 5100 and the first coil 5300 may face each other in a direction perpendicular to the optical axis (Z-axis).

The housing 1100 may include an opening, and the first coil 5300 disposed on the substrate 7000 may directly face the first magnet 5100 through the opening.

The first magnet 5100 may be configured as a moving member mounted on the carrier 4000 and moves in the optical axis (Z-axis) direction together with the carrier 4000, and the first coil 5300 may be configured as a fixed member fixed to the substrate 7000.

When power is applied to the first coil 5300, the carrier 4000 may move in the optical axis direction based on an electromagnetic force between the first magnet 5100 and the first coil 5300.

Since the lens module 2000 is accommodated in the carrier 4000, the lens module 2000 may also move in the optical axis direction by moving the carrier 4000. The aperture module 2 may also move in the optical axis direction together with the lens module 2000.

A first ball member Ba1 may be disposed between the carrier 4000 and the housing 1100. For example, the first ball member Ba1 may be disposed between the carrier 4000 and the housing 1100 and may reduce friction when the carrier 4000 moves.

The first ball member Ba1 may include a plurality of balls (BG1 and BG2) disposed in the optical axis direction. The plurality of balls may roll in the optical axis direction when the carrier 4000 moves in the optical axis direction.

The first pulling yoke 5700 may be disposed in the housing 1100. The first pulling yoke 5700 may be disposed in a position facing the first magnet 5100. For example, the first coil 5300 may be disposed on one surface of the substrate 7000, and the first pulling yoke 5700 may be disposed on the other surface of the substrate 7000.

Attractive force may be generated between the first magnet 5100 and the first pulling yoke 5700. For example, the first pulling yoke 5700 may be formed of a magnetic material. Attractive force may act in the direction perpendicular to the optical axis between the first magnet 5100 and the first pulling yoke 5700.

The first ball member Ba1 may be in contact with each of the carrier 4000 and the housing 1100 by the attractive force of first magnet 5100 and the first pulling yoke 5700.

An accommodation groove may be disposed on a surface on which the carrier 4000 and the housing 1100 face each other. For example, the carrier 4000 may include a first accommodation groove, and the housing 1100 may include a second accommodation groove.

Each of the first accommodation groove and the second accommodation groove may extend in the optical axis direction. The first ball member Ba1 may be disposed between the first accommodation groove and the second accommodation groove.

The first ball member Ba1 may include a first ball group BG1 and a second ball group BG2, and the first ball group BG1 and the second ball group BG2 may include a plurality of balls disposed in the optical axis (Z-axis) direction.

The first ball group BG1 and the second ball group BG2 may be spaced apart from each other in a direction perpendicular to the optical axis (e.g., X-axis direction). The number of balls in the first ball group BG1 and the number of balls in the second ball group BG2 may be different.

For example, the first ball group BG1 may include three or more balls disposed in the optical axis direction, and the second ball group BG2 may include fewer balls than the number of balls included in the first ball group BG1.

Assuming that the number of balls included in the first ball group BG1 and the number of balls included in the second ball group BG2 are different, the number of balls included in each ball member may be varied. Hereinafter, for ease of description, an embodiment in which the first ball group BG1 includes three balls and the second ball group BG2 includes two balls will be described.

In an example, among the three balls included in the first ball group BG1, two balls disposed on an outermost side in a direction parallel to the optical axis may have the same diameter, and one ball disposed therebetween may have a diameter smaller than that of the ball disposed on the outermost side.

In an example, the two balls included in the second ball group BG2 may have the same diameter.

In an embodiment, the camera actuator 3 may sense a position of the carrier 4000 in the optical axis (Z-axis) direction.

Accordingly, the first position sensor 5500 may be provided. The first position sensor 5500 may be disposed on the substrate 7000 to face the first magnet 5100. The first position sensor 5500 may be configured as a Hall sensor.

The camera actuator 3 may correct shaking while photographing by moving the lens module 2000 in a direction perpendicular to the optical axis (Z-axis). Accordingly, the camera actuator 3 may include a stabilization driver 6000 to move the lens module 2000 in a direction perpendicular to the optical axis (Z-axis).

The guide frame 3000 and the lens module 2000 may be accommodated in order in the carrier 4000. For example, the guide frame 3000 may be disposed between the carrier 4000 and the lens module 2000. The guide frame 3000 may have a quadrangular plate shape having a hollow therein.

Based on the driving force of the stabilization driver 6000, the guide frame 3000 and lens module 2000 may move together in one direction perpendicular to the optical axis (Z-axis), and the lens module 2000 may move relative to the guide frame 3000 in a direction perpendicular to the optical axis.

In an example, the guide frame 3000 and the lens module 2000 may move together in the second axis (X-axis) direction perpendicular to the optical axis, and the lens module 2000 may move relative to the guide frame 3000 in the third axis (Y-axis) direction perpendicular to both the optical axis and the second axis perpendicular to the optical axis.

Additionally, since the base 40 of the aperture module 2 is coupled to a lens module 2000, the aperture module 2 may also move in the second axis (X-axis) direction and the third axis (Y-axis) direction together with the lens module 2000.

The stabilization driver 6000 may include a first sub-driver 6100 and a second sub-driver 6300. The first sub-driver 6100 may generate a driving force in the second axis (X-axis) direction, and the second sub-driver 6300 may generate a driving force in the third axis (Y-axis) direction.

The first sub-driver 6100 may include a second magnet 6110 and a second coil 6130. The second magnet 6110 and the second coil 6130 may be disposed to face each other in the second axis (X-axis) direction.

The second magnet 6110 may be disposed on the lens module 2000. In an example, the second magnet 6110 may be mounted on one side surface of the lens holder 2200.

The second magnet 6110 may be magnetized such that one surface (e.g., the surface facing the second coil 6130 may have both an N pole and an S pole. In an example, one surface of the second magnet 6110 facing the second coil 6130 may include an N pole, a neutral region, and an S pole in order in the third axis (Y-axis) direction. The second magnet 6110 may have a shape having a length in the third axis (Y-axis) direction.

The second coil 6130 may be disposed to face the second magnet 6110. For example, the second coil 6130 may be disposed to face the second magnet 6110 in the second axis (X-axis) direction.

The second coil 6130 may have a toroid shape having a hollow therein, and a length in the second axis (Y-axis) direction. The second coil 6130 may include a plurality of coils. For example, the second coil 6130 may include two coils spaced apart from each other in the third axis (Y-axis) direction, and each coil may be disposed to face the second magnet 6110.

During image stabilization, the second magnet 6110 may be configured as a moving member mounted on the lens module 2000, and the second coil 6130 may be configured as a fixed member fixed to the housing 1100.

When power is applied to the second coil 6130, the lens module 2000 and the guide frame 3000 may move in the second axis (X-axis) direction based on an electromagnetic force between the second magnet 6110 and the second coil 6130.

The second magnet 6110 and the second coil 6130 may generate a driving force in the direction (e.g., first axis (X-axis) direction) in which the second magnet 6110 and the second coil 6130 faces each other.

The second sub-driver 6300 may include a third magnet 6310 and a third coil 6330. The third magnet 6310 and the third coil 6330 may be disposed to face each other in the second axis (Y-axis) direction.

The third magnet 6310 may be disposed on the lens module 2000. For example, the third magnet 6310 may be mounted on the other side surface of the lens holder 2200.

The third magnet 6310 may be magnetized such that one surface (e.g., the surface facing the third coil 6330 may have both an S pole and an N pole. For example, one surface of the third magnet 6310 facing the third coil 6330 may include an S pole, a neutral region, and an N pole in order in the second axis (X-axis) direction. The third magnet 6310 may have a shape having a length in the second axis (X-axis) direction.

The third coil 6330 may be disposed to face the third magnet 6310. For example, the third coil 6330 may be disposed to face the third magnet 6310 in the second axis (Y-axis) direction.

The second coil 6130 and the third coil 6330 may be provided on the substrate 7000. In an example, the second coil 6130 and the third coil 6330 may be disposed on the substrate 7000 to face the second magnet 6110 and the third magnet 6310.

The substrate 7000 may be mounted on a side surface of the housing 1100, and the second coil 6130 and the third coil 6330 may directly face a second magnet 6110 and a third magnet 6310 through an opening included in the housing 1100.

The third coil 6330 may have a toroid shape having a hollow therein, and a length in the first axis (X-axis) direction. The third coil 6330 may include a plurality of coils. For example, the third coil 6330 may include two coils spaced apart from each other in the first axis (X-axis) direction, and each coil may be disposed to face the third magnet 6310.

During image stabilization, the third magnet 6310 may be configured as a moving member mounted on the lens module 2000, and the third coil 6330 may be configured as a fixed member fixed to the housing 1100.

When power is applied to the third coil 6330, the lens module 2000 may move in the third axis (Y-axis) direction based on an electromagnetic force between the third magnet 6310 and the third coil 6330.

The third magnet 6310 and the third coil 6330 may generate a driving force in the direction (e.g., the third axis (Y-axis) direction) in which the third magnet 6310 and the third coil 6330 face each other.

The second magnet 6110 and the third magnet 6310 may be disposed perpendicular to each other on a plane perpendicular to the optical axis (Z-axis), and the second coil 6130 and the third coil 6330 may also be disposed perpendicular to each other on a plane perpendicular to the optical axis.

The camera actuator 3, in accordance with one or more embodiments, may include a plurality of ball members supporting the guide frame 3000 and the lens module 2000. The plurality of ball members may operate to guide movement of the guide frame 3000 and the lens module 2000 during the image stabilization process, and may also operate to maintain a distance among the carrier 4000, the guide frame 3000 and the lens module 2000.

The plurality of ball members may include a second ball member Ba2 and a third ball member Ba3.

The second ball member Ba2 may guide movement in the first axis (X-axis) direction of the guide frame 3000 and the lens module 2000, and the third ball member Ba3 may guide movement in the second axis (Y-axis) direction of the lens module 2000.

In an example, the second ball member Ba2 may roll in the second axis (X-axis) direction when a driving force occurs in the first axis (X-axis) direction. Accordingly, the second ball member Ba2 may guide movement of the guide frame 3000 and the lens module 2000 in the second axis (X-axis) direction.

The third ball member Ba3 may roll in the third axis (Y-axis) direction when a driving force in the third axis (Y-axis) direction occurs. Accordingly, the third ball member Ba3 may guide movement in the third axis (Y-axis) direction of the lens module 2000.

The second ball member Ba2 may include a plurality of ball members disposed between the carrier 4000 and the guide frame 3000, and the third ball member Ba3 may include a plurality of ball members disposed between the guide frame 3000 and the lens module 2000.

In an example, each of the second ball member Ba2 and the third ball member Ba3 may include four ball members.

A third accommodation groove 4100 that accommodates the second ball member Ba2 may be formed on at least one of surfaces of the carrier 4000 and the guide frame 3000 that face each other in the optical axis direction. The third accommodation groove 4100 may include a plurality of grooves corresponding to the plurality of ball members of the second ball member Ba2.

The second ball member Ba2 may be accommodated in the third accommodation groove 4100 and may be inserted between the carrier 4000 and the guide frame 3000.

While the second ball member Ba2 is accommodated in the third accommodation groove 4100, movement of the second ball member Ba2 in the optical axis and the third axis (Y-axis) direction may be limited, and the second ball member Ba2 may move only in the second axis (X-axis) direction. For example, the second ball member Ba2 may roll only in the second axis (X-axis) direction.

Accordingly, a plane of each of the plurality of grooves of the third accommodation groove 4100 may have a rectangular shape having a length in the second axis (X-axis) direction.

A fourth accommodation groove 3100 that accommodates the third ball member Ba3 may be formed on at least one of surfaces on which the guide frame 3000 and the lens module 2000 (e.g., the lens holder 2200) face each other in the optical axis (Z-axis) direction. The fourth accommodation groove 3100 may include a plurality of groove corresponding to the plurality of ball member of the third ball member Ba3.

The third ball member Ba3 may be accommodated in the fourth accommodation groove 3100 and may be inserted between the guide frame 3000 and the lens module 2000.

While the third ball member Ba3 is accommodated in the fourth accommodation groove 3100, movement of the third ball member Ba3 in the optical axis and second axis (X-axis) directions may be limited, and the third ball member Ba3 may move only in the third axis (Y-axis) direction. In an example, the third ball member Ba3 may roll only in the third axis (Y-axis) direction.

Accordingly, a plane of each of the plurality of grooves of the fourth accommodation groove 3100 may have a rectangular shape having a length in the third axis (Y-axis) direction.

When a driving force occurs in the second axis (X-axis) direction, the guide frame 3000 and the lens module 2000 may move together in the second axis (X-axis) direction. An aperture module 2 may also move in the second axis (X-axis) direction together with the lens module 2000.

In an example, the second ball member Ba2 may roll along the second axis (X-axis). In this example, movement of the third ball member Ba3 may be limited.

Additionally, when a driving force occurs in the third axis (Y-axis) direction, the lens module 2000 may move relative to the guide frame 3000 in the third axis (Y-axis) direction. The aperture module 2 may also move in the third axis (Y-axis) direction together with the lens module 2000.

In an example, the third ball member Ba3 may roll along the third axis (Y-axis). In this case, movement of the second ball member Ba2 may be limited.

In an embodiment, the camera actuator 3 may sense a position in a direction perpendicular to the optical axis (Z-axis) of the lens module 2000.

Accordingly, a second position sensor 6150 and a third position sensor 6350 may be provided. The second position sensor 6150 may be disposed on the substrate 7000 to face the second magnet 6110, and the third position sensor 6350 may be disposed on the substrate 7000 to face the third magnet 6310. The second position sensor 6150 and the third position sensor 6350 may be configured as Hall sensors.

At least one of the second position sensor 6150 and the third position sensor 6350 may include two Hall sensors. For example, the third position sensor 6350 may include two Hall sensors disposed to face the third magnet 6310.

Whether the lens module 2000 rotates may be sensed through two Hall sensors facing the third magnet 6310. Since the third coil 6330 includes two coils facing the third magnet 6310, rotational force applied to the lens module 2000 may be offset by controlling the third coil 6330.

Rotation of the lens module 2000 may be prevented by the third accommodation groove and the fourth accommodation groove in which the second ball member Ba2 and the third ball member Ba3 are disposed, but due to influence of tolerance occurring during the process of manufacturing a device, the lens module 2000 may rotate slightly.

However, the camera actuator 3 according to an embodiment may determine whether the lens module 2000 rotates by the third coil 6330 and the third position sensor 6350 and canceling the rotational force therefrom.

In embodiments, a second yoke and a third yoke may be provided such that the carrier 4000 and the guide frame 3000 may maintain to be in contact with the second ball member Ba2, and the guide frame 3000 and the lens module 2000 may maintain to be in contact with the third ball member Ba3.

The second yoke and the third yoke may be fixed to the carrier 4000 and may face the second magnet 6110 and the third magnet 6310 in the optical axis (Z-axis) direction.

Accordingly, an attractive force may occur between the second yoke and the second magnet 6110 and between the third yoke and the third magnet 6310 in the optical axis direction (Z-axis).

The lens module 2000 and the guide frame 3000 may be pressed in a direction toward the second yoke and the third yoke by attractive force between the second yoke and the third yoke, and the second magnet 6110 and third magnet 6310, such that the guide frame 3000 and the lens module 2000 may maintain to be in contact with the second ball member Ba2 and the third ball member Ba3.

The second yoke and the third yoke may be formed of a material generating an attractive force between the second magnet 6110 and the third magnet 6310. In an example, the second yoke and the third yoke may be formed of a magnetic material.

An OIS stopper 2300 may be coupled to the carrier 4000. The OIS stopper 2300 may be coupled to the carrier 4000 to cover at least a portion of an upper surface of the lens module 2000. For example, the OIS stopper 2300 may cover at least a portion of an upper surface of the lens holder 2200.

The OIS stopper 2300 may prevent the guide frame 3000 and the lens module 2000 from being separated from the carrier 4000 due to external impact.

Additionally, the AF stopper 2400 may be coupled to the housing 1100. The AF stopper 2400 may include a buffer protrusion disposed in a position facing the first ball member Ba1 and the optical axis (Z-axis) direction.

The AF stopper 2400 may prevent the carrier 4000 and the first ball member Ba1 from being released externally due to external impact.

Referring to FIGS. 13 and 14, the camera actuator 3 may include a connection board 8000. The connection board 8000 may connect an aperture substrate 530 of the aperture module 2 to a printed circuit board of the image sensor module.

In other words, the aperture substrate 530 may receive power through the connection board 8000.

The connection board 8000 may include a fixed portion 8100, a moving portion 8300, and a connection portion 8500. In an example, the connection board 8000 may be configured as an RF PCB.

The moving portion 8300 may be disposed on an internal side of the fixed portion 8100, and the connection portion 8500 may be disposed between the fixed portion 8100 and the moving portion 8300.

The fixed portion 8100 may be coupled to a case 1300 of the camera actuator 3. For example, the fixed portion 8100 may be mounted on an internal surface of the case 1300. The fixed portion 8100 may be a fixed member fixed to the case 1300. The fixed portion 8100 may be configured as a rigid PCB. The fixed portion 8100 may have a quadrangular frame shape.

A connector substrate that extends in the optical axis direction may be disposed on one side of the fixed portion 8100. The connector substrate may be connected to a printed circuit board of the image sensor module.

The moving portion 8300 may be coupled to an aperture module 2. For example, the moving portion 8300 may be mounted on the base 40 of the aperture module 2. The moving portion 8300 may be configured as a moving member moving together with the aperture module 2. The moving portion 8300 may be configured as a rigid PCB. The moving portion 8300 may have a ring shape.

One portion of the moving portion 8300 may be coupled to the aperture substrate 530 of the aperture module 2. For example, a connection pad may be disposed on one side of the moving portion 8300, and an aperture substrate 530 may be coupled to a connection pad of the moving portion 8300.

The connection portion 8500 may be disposed between the moving portion 8300 and the fixed portion 8100, and may connect the moving portion 8300 to the fixed portion 8100. For example, one side of the connection portion 8500 may be connected to the moving portion 8300, and the other side of the connection portion 8500 may be connected to the fixed portion 8100.

The connection portion 8500 may be configured as a flexible PCB. When the moving portion 8300 moves, the connection portion 8500 disposed between the moving portion 8300 and the fixed portion 8100 may be bent.

The connection portion 8500 may extend along a circumference of at least a portion of the moving portion 8300. The connection portion 8500 may have a single bridge shape component or a shape of a plurality of bridges.

Since the connection portion 8500 is configured to be bent, power may be stably supplied to the aperture module 2 even when the aperture module 2 moves together with the lens module 2000.

Since the aperture module 2 may move together with the lens module 2000, the magnet portion 510 and the coil portion 520 included in the aperture module 2 may also move together with the lens module 2000.

Accordingly, even when the lens module 2000 moves, a distance between the magnet portion 510 and the coil portion 520 may be maintained, thereby improving driving stability of the aperture module 2.

According to the aforementioned embodiments, the aperture module may ensure a wider dispositional space for the blades, thereby providing an aperture module operating stably.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An aperture module, comprising:
a base;
a rotator configured to rotate with respect to the base;
a plurality of blades configured to form incident holes having different sizes based on a rotation of the rotator;
a plurality of ball members disposed between the base and the rotator;
a magnet portion disposed on one of the rotator and the base; and
a coil portion disposed on another of the rotator and the base,
wherein an attractive force acts between the base and the rotator in a diagonal direction between a first axis direction parallel to an optical axis and a second axis direction perpendicular to the first axis direction.

2. The aperture module of claim 1, further comprising:
a first yoke disposed on the base; and
a second yoke disposed opposite to the first yoke with respect to the optical axis,
wherein the magnet portion comprises a first aperture magnet and a second aperture magnet disposed on opposite sides of each other with respect to the optical axis, and
wherein attractive forces act between the first aperture magnet and the first yoke in the first axis direction and the second axis direction.

3. The aperture module of claim 2, wherein an attractive force acts between the second aperture magnet and the second yoke in the first axis direction.

4. The aperture module of claim 1, further comprising:
a first yoke disposed on the base; and
a second yoke disposed opposite to the first yoke with respect to the optical axis,
wherein the magnet portion comprises a first aperture magnet and a second aperture magnet disposed on opposite sides of each other with respect to the optical axis, and
wherein an attractive force acting between the first aperture magnet and the first yoke is greater than an attractive force acting between the second aperture magnet and the second yoke.

5. The aperture module of claim 1,
wherein the base includes a yoke on which a magnetic attractive force that acts with the magnet portion acts,
wherein the yoke comprises a first yoke and a second yoke disposed on opposite sides of each other with respect to the optical axis, and
wherein a cross-section of the first yoke has an “L” shape.

6. The aperture module of claim 5, wherein an area of the first yoke is wider than an area of the second yoke.

7. The aperture module of claim 1, wherein the magnet portion and the coil portion are disposed to overlap each other in the second axis direction.

8. The aperture module of claim 1, further comprising:
a first yoke disposed on the base,
wherein the magnet portion comprises a first aperture magnet and a second aperture magnet disposed on opposite sides of each other with respect to the optical axis,
wherein the coil portion comprises a first aperture coil and a second aperture coil disposed on opposite sides of each other with respect to the optical axis, and
wherein the first yoke, the first aperture magnet, and the first aperture coil overlap each other in the second axis direction.

9. The aperture module of claim 1,
wherein a first portion of the plurality of ball members support the rotator in the first axis direction and the second axis direction, and
wherein a second portion of the plurality of ball members supports the rotator in the first axis direction.

10. The aperture module of claim 1,
wherein the magnet portion comprises a first aperture magnet and a second aperture magnet disposed on opposite sides of each other with respect to the optical axis,
wherein the plurality of ball members comprise a first rolling ball and a second rolling ball,
wherein the first rolling ball and the second rolling ball are spaced apart from each other in a circumferential direction of the rotator with the first aperture magnet therebetween, and
wherein the first rolling ball and the second rolling ball support the rotator in the first axis direction and the second axis direction.

11. An aperture module, comprising:
a base;
a rotator disposed to rotate with respect to the base;
a plurality of blades configured to form incident holes having different sizes based on a rotation of the rotator;
a plurality of ball members disposed between the base and the rotator;
a magnet portion disposed on the rotator;
a coil portion disposed on the base; and
a first yoke disposed on the base,
wherein the magnet portion comprises a first aperture magnet and a second aperture magnet disposed on opposite sides of an optical axis, and
wherein the first yoke overlaps the first aperture magnet in an optical axis direction and in a direction perpendicular to the optical axis.

12. The aperture module of claim 11, further comprising:
a second yoke disposed on an opposite side of the first yoke with respect to the optical axis,
wherein an attractive force acts between the second aperture magnet and the second yoke in the optical axis direction.

13. The aperture module of claim 11,
wherein the coil portion comprises a first aperture coil that faces the first aperture magnet, and
wherein the first aperture coil and the first aperture magnet are disposed to face each other in a direction perpendicular to the optical axis.

14. The aperture module of claim 12,
wherein the first yoke comprises a horizontal portion perpendicular to the optical axis direction, and
wherein a size of the second yoke is less than a size of the horizontal portion of the first yoke.

15. The aperture module of claim 11,
wherein a first portion of the plurality of ball members support the rotator in the optical axis direction and in a direction perpendicular to the optical axis, and
wherein a second portion of the plurality of ball members support the rotator in the optical axis direction.

16. The aperture module of claim 11,
wherein a portion of the plurality of ball members include a first rolling ball and a second rolling ball spaced apart from each other in a circumferential direction of the rotator with the first aperture magnet therebetween, and
wherein the first rolling ball and the second rolling ball support the rotator in a direction perpendicular to the optical axis.

17. A camera module, comprising:
a lens module; and
an aperture module,
wherein the aperture module comprises:
a base;
a rotator configured to rotate with respect to the base;
a plurality of blades configured to form incident holes having different sizes based on a rotation of the rotator;
a plurality of ball members disposed between the base and the rotator;
a magnet portion disposed on one of the rotator and the base; and
a coil portion disposed on another of the rotator and the base,
wherein an attractive force acts between the base and the rotator in a diagonal direction between a first axis direction parallel to an optical axis and a second axis direction perpendicular to the first axis direction.
